(19) United States
(12) Patent Application Publication
(10) Pub. No.: US 2026/0084529 A1
(43) Pub. Date: Mar. 26, 2026

(54) DETECTING AND MITIGATING VEHICLE INSTRUMENT CLUSTER DISPLAY OBSTRUCTIONS

(71) Applicant: GM Global Technology Operations LLC, Detroit, MI (US)

(72) Inventors: Omer Tsimhoni, Warren, MI (US); Monica Malden-Stevens, Grosse Ile, MI (US); Kai-Han Chang, Madison Heights, MI (US); Thomas A. Seder, Fraser, MI (US); Matthew R. Bert, Troy, MI (US)

(21) Appl. No.: 18/896,269

(22) Filed: Sep. 25, 2024

(51) Int. Cl. B60K 35/40; B60K 35/28; G06F 3/01; G09G 5/14

(52) U.S. Cl. CPC B60K 35/40; B60K 35/28; G06F 3/013; G09G 5/14; B60K 2360/741; G09G 2340/0464; G09G 2354/00; G09G 2380/10

(57) ABSTRACT

A method for increasing display visibility in a vehicle may include determining an occupant eye position of an occupant of the vehicle using an occupant position tracking device. The method further may include determining a region obstruction status of each of a plurality of regions of an instrument cluster display of the vehicle based at least in part on the occupant eye position. The region obstruction status includes one of: an obstructed status and an unobstructed status. The method further may include performing an obstruction mitigating action in response to determining that the region obstruction status of one or more of the plurality of regions of the instrument cluster display is the obstructed status.

### INTRODUCTION

The present disclosure relates to systems and methods for providing information to occupants of vehicles.

To increase occupant awareness and convenience, vehicles may be equipped with one or more analog or digital displays for providing information to vehicle occupants. For example, vehicles may be equipped with an instrument cluster display disposed on a dashboard of the vehicle. The instrument cluster display may be used to display information relevant to the operation of the vehicle, such as, for example, vehicle speed, engine rotational speed, fuel level, state of charge, engine temperature, transmission temperature, electric motor temperature, battery temperature, tire pressure, and/or the like. The instrument cluster display may also be used to indicate the operation and/or enablement of vehicle features and components, such as, for example, turn signals, headlights, running lights, driver assistance features, and/or the like. However, one or more regions of the instrument cluster display may not be visible to the occupant because of, for example, the position of the occupant relative to the instrument cluster display, the position of other vehicle components (e.g., a steering wheel, a seat, etc.), and/or the like.

Thus, while current vehicle information systems and methods achieve their intended purpose, there is a need for a new and improved system and method to detect obstructed regions of the instrument cluster display and perform obstruction mitigating actions to increase occupant awareness.

### SUMMARY

According to several aspects, a method for increasing display visibility in a vehicle is provided. The method may include determining an occupant eye position of an occupant of the vehicle using an occupant position tracking device. The method further may include determining a region obstruction status of each of a plurality of regions of an instrument cluster display of the vehicle based at least in part on the occupant eye position. The region obstruction status includes one of: an obstructed status and an unobstructed status. The method further may include performing an obstruction mitigating action in response to determining that the region obstruction status of one or more of the plurality of regions of the instrument cluster display is the obstructed status.

In another aspect of the present disclosure, determining the region obstruction status of each of the plurality of regions of the instrument cluster display further may include determining a plurality of eyeboxes. Each of the plurality of eyeboxes describes a volume in three-dimensional space within which the occupant can see one of the plurality of regions. Each of the plurality of eyeboxes corresponds to a corresponding one of the plurality of regions. Determining the region obstruction status of each of the plurality of regions of the instrument cluster display further may include determining the region obstruction status of each of the plurality of regions based at least in part on the plurality of eyeboxes and the occupant eye position.

In another aspect of the present disclosure, determining the plurality of eyeboxes further may include determining a position of the instrument cluster display. Determining the plurality of eyeboxes further may include determining a position of a steering wheel of the vehicle. Determining the plurality of eyeboxes further may include determining the plurality of eyeboxes based at least in part on the position of the instrument cluster display and the position of the steering wheel of the vehicle.

In another aspect of the present disclosure, determining the plurality of eyeboxes further may include determining the plurality of eyeboxes using a geometrical model of a vehicle interior of the vehicle based at least in part on the position of the instrument cluster display and the position of the steering wheel of the vehicle.

In another aspect of the present disclosure, determining the region obstruction status further may include determining a percentage of a predetermined time period for which the occupant eye position is within each of the plurality of eyeboxes. Determining the region obstruction status further may include determining the region obstruction status of each of the plurality of regions based at least in part on the percentage of the predetermined time period for which the occupant eye position is within each of the plurality of eyeboxes.

In another aspect of the present disclosure, determining the region obstruction status further may include determining the region obstruction status of each of the plurality of regions by comparing the percentage of the predetermined time period for which the occupant eye position is within each of the plurality of eyeboxes to a predetermined threshold.

In another aspect of the present disclosure, determining the region obstruction status of each of the plurality of regions of the instrument cluster display further may include determining a plurality of sightlines between the occupant eye position and each of the plurality of regions. Each of the plurality of sightlines corresponds to a corresponding one of the plurality of regions. Determining the region obstruction status of each of the plurality of regions of the instrument cluster display further may include determining a sightline obstruction status of each of the plurality of sightlines using a geometrical model of a vehicle interior of the vehicle based at least in part on: a position of the instrument cluster display and a position of a steering wheel of the vehicle. The sightline obstruction status includes one of: the obstructed status and the unobstructed status. Determining the region obstruction status of each of the plurality of regions of the instrument cluster display further may include determining the region obstruction status of each of the plurality of regions of the instrument cluster display to be equal to the sightline obstruction status of a corresponding one of the plurality of sightlines.

In another aspect of the present disclosure, performing the obstruction mitigating action further may include prompting the occupant to reposition at least one of: an occupant seat, a steering wheel of the vehicle, and the instrument cluster display.

In another aspect of the present disclosure, performing the obstruction mitigating action further may include repositioning the instrument cluster display using an instrument cluster display actuator.

In another aspect of the present disclosure, performing the obstruction mitigating action further may include repositioning one or more user interface elements displayed in a first region of the one or more of the plurality of regions having the obstructed status to a second region of the one or more of the plurality of regions having the unobstructed status.

According to several aspects, a system for increasing display visibility in a vehicle is provided. The system may include an instrument cluster display, an occupant position tracking device, a seat position sensor, and a controller in electrical communication with the instrument cluster display, the occupant position tracking device, and the seat position sensor. The controller is programmed to determine an occupant eye position of an occupant of the vehicle using the occupant position tracking device and the seat position sensor. The controller is further programmed to determine a region obstruction status of each of a plurality of regions of the instrument cluster display of the vehicle based at least in part on the occupant eye position. The region obstruction status includes one of: an obstructed status and an unobstructed status. The controller is further programmed to reposition one or more user interface elements displayed in a first region of the one or more of the plurality of regions of the instrument cluster display having the obstructed status to a second region of the one or more of the plurality of regions of the instrument cluster display having the unobstructed status.

In another aspect of the present disclosure, to determine the region obstruction status of each of the plurality of regions of the instrument cluster display, the controller is further programmed to determine a plurality of eyeboxes. Each of the plurality of eyeboxes describes a volume in three-dimensional space within which the occupant can see one of the plurality of regions. Each of the plurality of eyeboxes corresponds to a corresponding one of the plurality of regions. To determine the region obstruction status of each of the plurality of regions of the instrument cluster display, the controller is further programmed to determine the region obstruction status of each of the plurality of regions based at least in part on the plurality of eyeboxes and the occupant eye position.

In another aspect of the present disclosure, to determine the plurality of eyeboxes, the controller is further programmed to determine a position of the instrument cluster display. To determine the plurality of eyeboxes, the controller is further programmed to determine a position of a steering wheel of the vehicle. To determine the plurality of eyeboxes, the controller is further programmed to determine the plurality of eyeboxes using a geometrical model of a vehicle interior of the vehicle based at least in part on: the position of the instrument cluster display and the position of the steering wheel of the vehicle.

In another aspect of the present disclosure, to determine the region obstruction status, the controller is further programmed to determine a percentage of a predetermined time period for which the occupant eye position is within each of the plurality of eyeboxes. To determine the region obstruction status, the controller is further programmed to determine the region obstruction status of each of the plurality of regions by comparing the percentage of the predetermined time period for which the occupant eye position is within each of the plurality of eyeboxes to a predetermined threshold.

In another aspect of the present disclosure, to determine the region obstruction status of each of the plurality of regions of the instrument cluster display, the controller is further programmed to determine a plurality of sightlines between the occupant eye position and each of the plurality of regions. Each of the plurality of sightlines corresponds to a corresponding one of the plurality of regions. To determine the region obstruction status of each of the plurality of regions of the instrument cluster display, the controller is further programmed to determine a sightline obstruction status of each of the plurality of sightlines. The sightline obstruction status includes one of: the obstructed status and the unobstructed status. To determine the region obstruction status of each of the plurality of regions of the instrument cluster display, the controller is further programmed to determine the region obstruction status of each of the plurality of regions of the instrument cluster display based at least in part on the region obstruction status of each of the plurality of sightlines.

In another aspect of the present disclosure, to determine the sightline obstruction status of each of the plurality of sightlines, the controller is further programmed to determine the sightline obstruction status of each of the plurality of sightlines using a geometrical model of a vehicle interior of the vehicle based at least in part on: a position of the instrument cluster display and a position of a steering wheel of the vehicle.

In another aspect of the present disclosure, to determine the region obstruction status of each of the plurality of regions of the instrument cluster display, the controller is further programmed to determine the region obstruction status of each of the plurality of regions of the instrument cluster display to be equal to the sightline obstruction status of a corresponding one of the plurality of sightlines.

According to several aspects, a method for increasing display visibility in a vehicle is provided. The method may include determining an occupant eye position of an occupant of the vehicle using an occupant position tracking device. The method further may include determining a region obstruction status of each of a plurality of regions of an instrument cluster display of the vehicle based at least in part on the occupant eye position. The region obstruction status includes one of: an obstructed status and an unobstructed status. The method further may include performing an obstruction mitigating action in response to determining that the region obstruction status of one or more of the plurality of regions of the instrument cluster display is the obstructed status. The obstruction mitigating action includes repositioning the instrument cluster display using an instrument cluster display actuator.

In another aspect of the present disclosure, determining the region obstruction status of each of the plurality of regions of the instrument cluster display further may include determining a position of the instrument cluster display. Determining the region obstruction status of each of the plurality of regions of the instrument cluster display further may include determining a position of a steering wheel of the vehicle. Determining the region obstruction status of each of the plurality of regions of the instrument cluster display further may include determining a plurality of eyeboxes based at least in part on the position of the instrument cluster display and the position of the steering wheel of the vehicle. Each of the plurality of eyeboxes describes a volume in three-dimensional space within which the occupant can see one of the plurality of regions. Each of the plurality of eyeboxes corresponds to a corresponding one of the plurality of regions. Determining the region obstruction status of each of the plurality of regions of the instrument cluster display further may include determining a percentage of a predetermined time period for which the occupant eye position is within each of the plurality of eyeboxes. Determining the region obstruction status of each of the plurality of regions of the instrument cluster display further may include determining the region obstruction status of each of the plurality of regions by comparing the percentage of the predetermined time period for which the occupant eye position is within each of the plurality of eyeboxes to a predetermined threshold.

In another aspect of the present disclosure, performing the obstruction mitigating action further may include repositioning one or more user interface elements displayed in a first region of the one or more of the plurality of regions having the obstructed status to a second region of the one or more of the plurality of regions having the unobstructed status.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for increasing display visibility in a vehicle, according to an exemplary embodiment;

FIG. 2 is a flowchart of a method for increasing display visibility in a vehicle, according to an exemplary embodiment;

FIG. 3 is a diagram of an instrument cluster display within the vehicle showing a plurality of regions, according to an exemplary embodiment;

FIG. 4A is a diagram of the instrument cluster display within the vehicle showing an initial condition before any obstruction mitigating action according to an exemplary embodiment;

FIG. 4B is a diagram of the instrument cluster display within the vehicle showing a first user interface obstruction mitigating action, according to an exemplary embodiment;

FIG. 4C is a diagram of the instrument cluster display within the vehicle showing a second user interface obstruction mitigating action, according to an exemplary embodiment;

FIG. 4D is a diagram of the instrument cluster display within the vehicle showing a third user interface obstruction mitigating action, according to an exemplary embodiment;

FIG. 4E is a diagram of the instrument cluster display within the vehicle showing a fourth user interface obstruction mitigating action, according to an exemplary embodiment;

FIG. 5 is a first method for determination of a region obstruction status for each of a plurality of regions of the instrument cluster display, according to an exemplary embodiment;

FIG. 6 is a first schematic diagram of the occupant viewing the instrument cluster display, according to an exemplary embodiment;

FIG. 7 is a second method for determination of the region obstruction status for each of the plurality of regions of the instrument cluster display, according to an exemplary embodiment; and

FIG. 8 is a first schematic diagram of the occupant viewing the instrument cluster display, according to an exemplary embodiment.

### DETAILED DESCRIPTION

The following description is merely exemplary in nature and is not intended to limit the present disclosure, application, or uses.

In aspects of the present disclosure, instrument cluster displays are used to provide vehicle occupants with information about the operation of the vehicle. In some instances, one or more regions of the instrument cluster display may not be visible to the occupant because of, for example, the position of the occupant relative to the instrument cluster display, the position of other vehicle components (e.g., a steering wheel, a seat, etc.), and/or the like. Accordingly, the present disclosure provides a new and improved system and method to detect obstructed regions of the instrument cluster display and perform obstruction mitigating actions to increase occupant awareness.

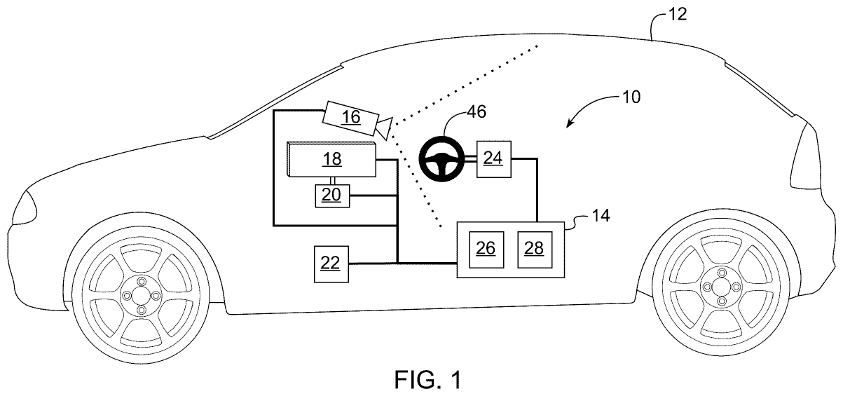

Referring to FIG. 1, a system for increasing display visibility in a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, an occupant position tracking device 16, an instrument cluster display 18, an instrument cluster display actuator 20, a seat position sensor 22, and a steering wheel and column position sensor 24.

The controller 14 is used to implement a method 100 for increasing display visibility in a vehicle, as will be described below. The controller 14 includes at least one processor 26 and a non-transitory computer readable storage device or media 28. The processor 26 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions.

The computer readable storage device or media 28 may include volatile and nonvolatile storage in read-only memory (ROM), random-access memory (RAM), and keep-alive memory (KAM), for example. KAM is a persistent or non-volatile memory that may be used to store various operating variables while the processor 26 is powered down. The computer-readable storage device or media 28 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12.

The controller 14 may also consist of multiple controllers which are in electrical communication with each other. The controller 14 may be inter-connected with additional systems and/or controllers of the vehicle 12, allowing the controller 14 to access data such as, for example, speed, acceleration, braking, and steering angle of the vehicle 12.

The controller 14 is in electrical communication with the occupant position tracking device 16, the instrument cluster display 18, the instrument cluster display actuator 20, the seat position sensor 22, and the steering wheel and column position sensor 24. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure. It should further be understood that, in the scope of the present disclosure, electrical communication also includes power and/or energy transfer between electrical devices (e.g., using conducting wires and/or wireless power transmission techniques).

The occupant position tracking device 16 is used to determine a position of an occupant 40 in the vehicle 12. In the scope of the present disclosure, the occupant includes, in a non-limiting example, a driver, a passenger, and/or any additional persons in the vehicle 12. For example, the occupant position tracking device 16 may track a position of a head 42 or eyes 44 of the occupant 40. In an exemplary embodiment, the occupant position tracking device 16 includes one or more cameras disposed in the vehicle 12, for example, as part of a driver monitoring system (DMS) used to monitor occupant attentiveness when using automated driving or driver assistance features. In a non-limiting example, the one or more cameras of the occupant position tracking device 16 are disposed in a headliner of the vehicle 12, for example, proximal to a rear-view mirror of the vehicle 12. In another non-limiting example, the one or more cameras of the occupant position tracking device 16 are disposed on a steering column of the vehicle 12. In another non-limiting example, the one or more cameras of the occupant position tracking device 16 are disposed on an A-pillar of the vehicle 12. In another non-limiting example, the one or more cameras of the occupant position tracking device 16 are disposed behind the instrument cluster display 18. The occupant position tracking device 16 is in electrical communication with the controller 14 as described above.

The instrument cluster display 18 is used to provide information to the occupant 40 of the vehicle 12. In an exemplary embodiment, the instrument cluster display 18 is a human-machine interface (HMI) located in view of the occupant 40 and capable of displaying text, graphics, and/or images (e.g., including LCD displays, LED displays, and/or the like). In a non-limiting example, the instrument cluster display 18 is used by the controller 14 to display information relevant to the operation of the vehicle 12, such as, for example, vehicle speed, engine rotational speed, fuel level, state of charge, engine temperature, transmission temperature, electric motor temperature, battery temperature, tire pressure, and/or the like.

The instrument cluster display 18 is further used to indicate the operation and/or enablement of vehicle features and components, such as, for example, turn signals, headlights, running lights, driver assistance features (cruise control, lane keep assist, and/or the like), and/or the like. The instrument cluster display 18 is further used to indicate fault conditions with vehicle systems such as, for example, safety systems, propulsion systems, braking systems, and/or the like. The instrument cluster display 18 is further used to provide information about additional vehicle features such as, for example, navigation information, infotainment information, and/or the like.

In an exemplary embodiment, the instrument cluster display 18 is disposed behind a steering wheel 46 of the vehicle 12. In a non-limiting example, a position of the instrument cluster display 18 may be adjusted in one or more axes manually by the occupant 40 and/or by the instrument cluster display actuator 20, as will be discussed in greater detail below. Accordingly, in a non-limiting example, the instrument cluster display 18 is movably affixed to the vehicle 12 using, for example, one or more hinges, joints, linkages, and/or the like. In an exemplary embodiment, the occupant 40 may interact with the instrument cluster display 18 using a human-interface device (HID), including, for example, a touchscreen, an electromechanical switch, a capacitive switch, a rotary knob, and/or the like. In a non-limiting example, the HID is disposed on the steering wheel 46 and/or the steering column. It should be understood that the instrument cluster display 18 may also include displays which span large sections of a dashboard of the vehicle 12, including, for example, displays spanning from A-pillar to A-pillar or from A-pillar to center console. The instrument cluster display 18 is in electrical communication with the controller 14 as described above.

The instrument cluster display actuator 20 is used to adjust the position of the instrument cluster display 18. In an exemplary embodiment, the instrument cluster display actuator 20 is an electric actuator (e.g., a direct current (DC) electric motor) in mechanical communication with the instrument cluster display 18. In a non-limiting example, the instrument cluster display actuator 20 is a DC electric motor directly coupled to the instrument cluster display 18 and configured to tilt the instrument cluster display 18. In another non-limiting example, the instrument cluster display actuator 20 is a DC electric motor directly coupled to the instrument cluster display 18 and configured to pan the instrument cluster display 18.

In another non-limiting example, the instrument cluster display actuator 20 is a linear actuator configured to move the instrument cluster display 18 vertically up and down relative to the steering wheel 46. In another non-limiting example, the instrument cluster display actuator 20 is a linear actuator configured to move the instrument cluster display 18 horizontally left and right relative to the steering wheel 46.

In an exemplary embodiment, the instrument cluster display actuator 20 further includes one or more position sensors allowing for determination of a position of the instrument cluster display 18. In a non-limiting example, the one or more position sensors include, for example, a rotary encoder, a linear encoder, a potentiometer, a hall-effect sensor, and/or the like.

It should be understood that the instrument cluster display actuator 20 may include any type of actuator producing rotational, linear, or other motion without departing from the scope of the present disclosure. Furthermore, the instrument cluster display actuator 20 may be in mechanical communication with the instrument cluster display 18 using any configuration or combination of linkages, gears, belts, pullies, pistons, screw drives, and/or the like without departing from the scope of the present disclosure. The instrument cluster display actuator 20 is in electrical communication with the controller 14 as described above.

The seat position sensor 22 is used to determine a position of an occupant seat 48 of the vehicle 12. In an exemplary embodiment, the occupant seat 48 is configured to be moved in one or more axes to achieve a comfortable seating position for the occupant 40. In a non-limiting example, the seat position sensor 22 includes a sensor to determine the position of the occupant seat 48 horizontally in a forward and backward direction (i.e., substantially parallel to a direction of travel of the vehicle 12). In another non-limiting example, the seat position sensor 22 includes a sensor to determine the position of the occupant seat 48 vertically in an up and down direction (i.e., substantially parallel to the force of gravity on the vehicle 12).

In another non-limiting example, the seat position sensor 22 includes a plurality of sensors to determine the position of the occupant seat 48 horizontally in a forward and backward direction and to determine the position of the occupant seat 48 vertically in an up and down direction. In an exemplary embodiment, the seat position sensor 22 is a digital or analog electrical sensor including, for example, an opto-electrical sensor (e.g., a laser range finding sensor, a beam break sensor, and/or the like), an electromechanical sensor (e.g., a rotary encoder, a linear encoder, a potentiometer, and/or the like), an electromagnetic sensor (e.g., a reed switch, a hall-effect sensor, and/or the like), and/or the like. The seat position sensor 22 is in electrical communication with the controller 14 as described above.

The steering wheel and column position sensor 24 is used to determine a rotational position of the steering wheel 46 and a position of a steering column of the vehicle 12. In an exemplary embodiment, the steering column is configured to be moved in one or more axes to achieve a comfortable driving position for the occupant 40. In a non-limiting example, the steering wheel and column position sensor 24 includes a sensor to determine the position of the steering column horizontally in a forward and backward direction (i.e., substantially parallel to a direction of travel of the vehicle 12). In another non-limiting example, the steering wheel and column position sensor 24 includes a sensor to determine the position of the steering column vertically in an up and down direction (i.e., substantially parallel to the force of gravity on the vehicle 12).

In another non-limiting example, the steering wheel and column position sensor 24 includes a plurality of sensors to determine the position of the steering column horizontally in a forward and backward direction and to determine the position of the steering column vertically in an up and down direction.

In a non-limiting example, the steering wheel and column position sensor 24 further includes one or more sensors for determining a rotational angle of the steering wheel 46 relative to the steering column. In an exemplary embodiment, the steering wheel and column position sensor 24 includes one or more digital or analog electrical sensors including, for example, an opto-electrical sensor (e.g., a laser range finding sensor, a beam break sensor, and/or the like), an electromechanical sensor (e.g., a rotary encoder, a linear encoder, a potentiometer, and/or the like), an electromagnetic sensor (e.g., a reed switch, a hall-effect sensor, and/or the like), and/or the like. The steering wheel and column position sensor 24 is in electrical communication with the controller 14 as described above.

Referring to FIG. 2, a flowchart of the method 100 for increasing display visibility in a vehicle is shown. The method 100 begins at block 102 and proceeds to block 104. At block 104, the controller 14 determines an occupant eye position of the eyes 44 of the occupant 40 using the occupant position tracking device 16. In an exemplary embodiment, the controller 14 uses the one or more cameras of the occupant position tracking device 16 to detect the eyes 44 and determine the occupant eye position. In a non-limiting example, the occupant eye position is defined as an average position of both of a left eye and a right eye of the occupant 40. In another non-limiting example, the occupant eye position includes both an occupant left eye position of the left eye and an occupant right eye position of the occupant right eye.

In an exemplary embodiment, the controller 14 further uses the seat position sensor 22 to gather additional information about the position of the occupant 40. In a non-limiting example, the controller 14 uses the seat position sensor 22 to determine the position of the occupant seat 48 horizontally in the forward and backward direction and to determine the position of the occupant seat 48 vertically in the up and down direction. In a non-limiting example, the controller 14 fuses data from both the occupant position tracking device 16 and the seat position sensor 22 to determine the occupant eye position. In an exemplary embodiment, the controller 14 repeatedly and periodically determines the occupant eye position and saves a database of past occupant eye positions and timestamps in the media 28 of the controller 14. After block 104, the method 100 proceeds to block 106.

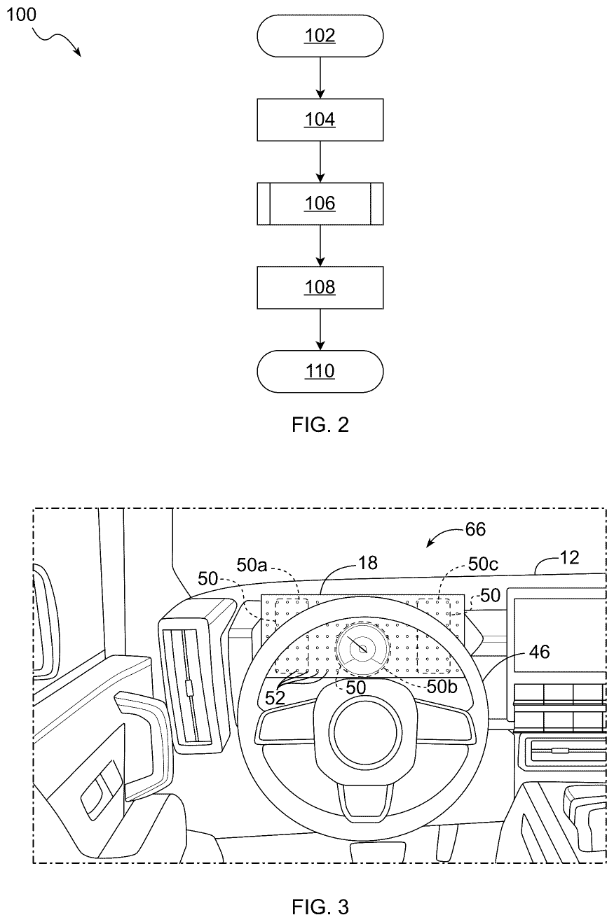

Referring to FIG. 3, a diagram of the instrument cluster display 18 within the vehicle 12 showing a plurality of regions 50 is shown. In an exemplary embodiment, the instrument cluster display 18 is divided into the plurality of regions 50, including, for example, a first region 50a, a second region 50b, and a third region 50c. Each of the plurality of regions encompasses one or more of a plurality of points 52 (e.g., pixels) which describe point locations on the instrument cluster display 18. In a non-limiting example, the plurality of regions 50 are divided based on where various types of information are typically shown on the instrument cluster display 18. For example, in some embodiments, the second region 50b may contain a speedometer indicating a speed of the vehicle 12 and therefore may be designated as a critical region. In another example, the first region 50a may contain infotainment information and therefore may be designated as a non-critical region. It should be understood that the plurality of regions 50 are not necessarily physical boundaries, but rather may be software representations useful to locate various user interface elements on the instrument cluster display 18.

In some instances, one or more of the plurality of regions 50 may be obstructed (i.e., partially or fully not viewable by the occupant 40) by vehicle components (e.g., the steering wheel 46) from one or more viewing angles. For example, from the perspective shown in FIG. 3, the first region 50a is considered to be obstructed by the steering wheel 46. Therefore, each of the plurality of regions 50 has a region obstruction status based on the occupant eye position. The region obstruction status includes one of: an obstructed status or an unobstructed status. The obstructed status indicates that a given region is obstructed (e.g., not fully viewable) from the perspective of the occupant eye position. The unobstructed status indicates that a given region is unobstructed (e.g., fully viewable) from the perspective of the occupant eye position.

Referring again to FIG. 2 with continued reference to FIG. 3, at block 106, the controller 14 determines the region obstruction status for each of the plurality of regions 50.

In an exemplary embodiment, the controller 14 determines the region obstruction status for each of the plurality of regions 50 using an obstruction calibration routine. In a non-limiting example, the obstruction calibration routine includes displaying a plurality of graphics in each of the plurality of regions 50 of the instrument cluster display 18 and prompting the occupant 40 to provide feedback as to whether each of the plurality of graphics is visible. Based on the information provided by the occupant 40, the controller 14 determines one or more of the plurality of regions 50 to have the obstructed status.

In an exemplary embodiment, the controller 14 determines the region obstruction status for each of the plurality of regions 50 based at least in part on the occupant eye position determined at block 104. Additional methods for determination of the region obstruction status for each of the plurality of regions 50 will be discussed in greater detail below. After block 106, the method 100 proceeds to block 108.

At block 108, the controller 14 performs an obstruction mitigating action in response to determining that the region obstruction status of one or more of the plurality of regions 50 of the instrument cluster display 18 is the obstructed status. In an exemplary embodiment, the obstruction mitigating action includes providing a prompt to the occupant 40. In a non-limiting example, the prompt instructs the occupant 40 to reposition one or more of: the occupant seat 48, the steering wheel 46, and/or the instrument cluster display 18 to mitigate the obstruction. As discussed above, in some examples, the instrument cluster display 18 is manually movable by the occupant 40 and/or movable using the instrument cluster display actuator 20. In a non-limiting example, the prompt is provided to the occupant 40 by displaying a message on the instrument cluster display 18 in one of the plurality of regions 50 having the unobstructed region obstruction status.

In another exemplary embodiment, the obstruction mitigating action includes automatically repositioning the instrument cluster display 18 using the instrument cluster display actuator 20. In a non-limiting example, the controller 14 commands the instrument cluster display actuator 20 to move the instrument cluster display 18. In a non-limiting example, a magnitude and direction of the movement of the instrument cluster display actuator 20 is determined based at least in part on a location of the one or more obstructed regions. In another non-limiting example, the magnitude and direction of the movement of the instrument cluster display actuator 20 is determined based at least in part on a position of the steering wheel 46. In another non-limiting example, the magnitude and direction of the movement of the instrument cluster display actuator 20 is determined based at least in part on the occupant eye position. In another non-limiting example, the instrument cluster display actuator 20 is continuously or repeatedly actuated until none of the plurality of regions 50 have the obstructed region obstruction status.

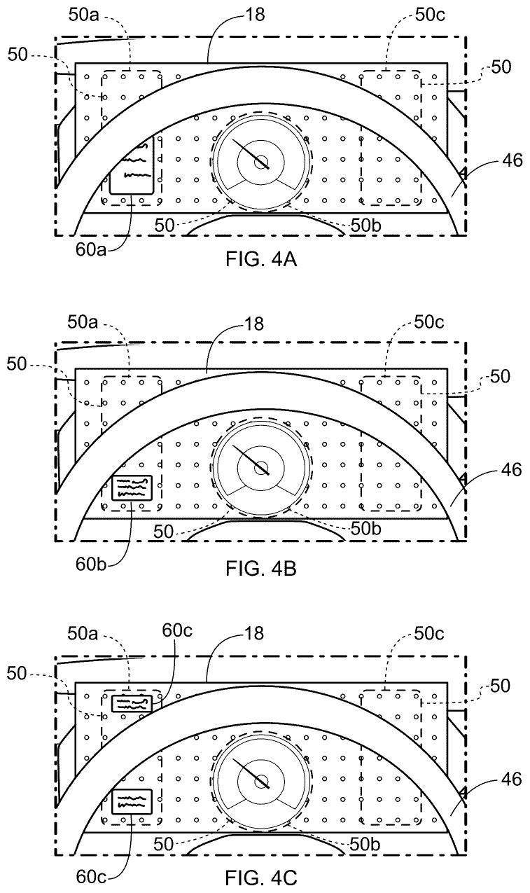

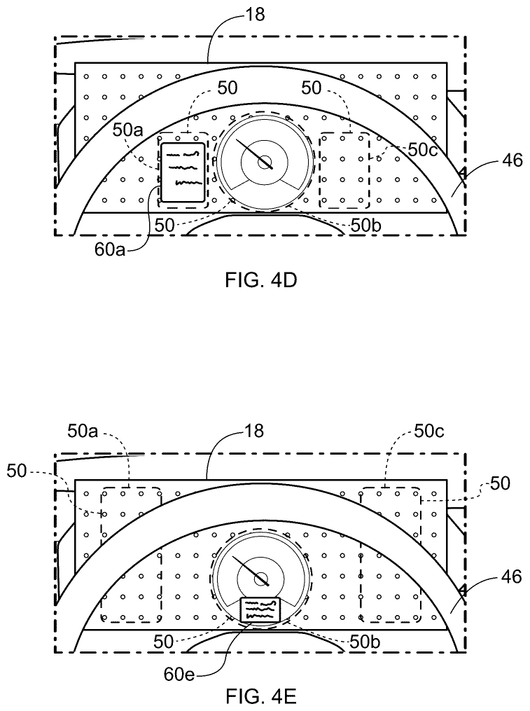

Referring to FIGS. 4A-4E, diagrams of the instrument cluster display 18 within the vehicle 12 showing exemplary obstruction mitigating actions are shown. Referring to FIG. 4A, an initial condition before any obstruction mitigating action is shown. In the initial condition, a first exemplary user interface element 60a displayed in the first region 50a is obstructed by the steering wheel 46. Referring to FIG. 4B, in another exemplary embodiment, the obstruction mitigating action includes displaying a second exemplary user interface element 60b which is not obstructed. In a non-limiting example, the second exemplary user interface element 60b presents the same information as the first exemplary user interface element 60a, but has an adjusted shape, size, and/or position relative to the first exemplary user interface element 60a.

Referring to FIG. 4C, in another exemplary embodiment, the obstruction mitigating action includes displaying a third exemplary user interface element 60c which is not obstructed. In a non-limiting example, the third exemplary user interface element 60c presents the same information as the first exemplary user interface element 60a, but includes two or more separate elements which are not obstructed.

Referring to FIG. 4D, in another exemplary embodiment, the obstruction mitigating action includes resizing, reshaping, and/or repositioning the plurality of regions 50 such that the plurality of regions are not obstructed. In a non-limiting example, both the first region 50a and the second region 50b are resized and repositioned as shown in FIG. 4D. Referring to FIG. 4E, in another exemplary embodiment, the obstruction mitigating action includes displaying a fourth exemplary user interface element 60e in one of the plurality of regions 50 having the unobstructed status. In a non-limiting example, the fourth exemplary user interface element 60e is displayed in the second region 50b. In a non-limiting example, the fourth exemplary user interface element 60e presents the same information as the first exemplary user interface element 60a, but is displayed in one of the plurality of regions 50 which is unobstructed. Therefore, the first exemplary user interface element 60a is effectively repositioned from the first region 50a having the obstructed status to the second region 50b having the unobstructed status.

In an exemplary embodiment, rule-based criteria are used to determine how to rearrange the information displayed on the instrument cluster display 18. In a non-limiting example, the rule-based criteria disallow repositioning of information from non-critical regions into critical regions to ensure that all information in critical regions remains visible to the occupant 40. In an exemplary embodiment, historical obstruction mitigation activity is used to determine the obstruction mitigating action. In a non-limiting example, the controller 14 retrieves information about previously performed obstruction mitigating actions from the media 28 of the controller 14 and performs the obstruction mitigating action based at least in part on the previously performed obstruction mitigating actions.

It should be understood that the aforementioned obstruction mitigating actions are not limiting, and that any physical repositioning or adjustment of the instrument cluster display 18 and/or any software adjustment of the content displayed on the instrument cluster display 18 (e.g., resizing, reshaping, rearrangement, repositioning, animation, and/or the like of user interface elements) is within the scope of the present disclosure. Referring again to FIG. 2, after block 108, the method 100 proceeds to enter a standby state at block 110.

In an exemplary embodiment, the controller 14 repeatedly exits the standby state 110 and restarts the method 100 at block 102. In a non-limiting example, the controller 14 exits the standby state 110 and restarts the method 100 on a timer, for example, every three hundred milliseconds.

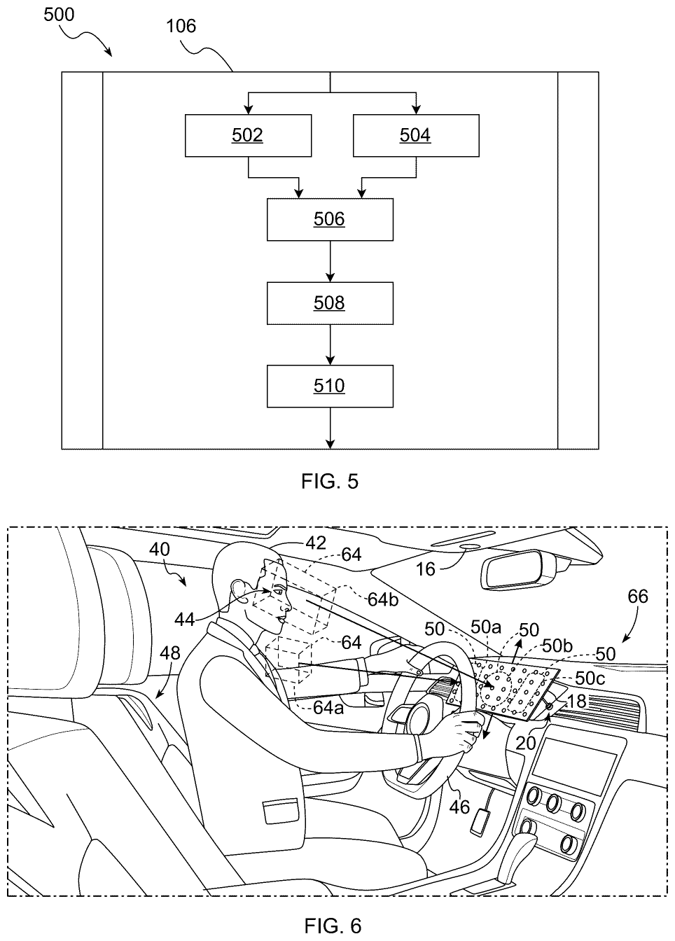

Referring to FIG. 5, a flowchart of a first exemplary embodiment 500 of block 106 (i.e., a first method for determination of the region obstruction status for each of the plurality of regions 50) is shown. The first exemplary embodiment 500 of block 106 begins at blocks 502 and 504. At block 502, the controller 14 determines the position of the steering wheel 46 using the steering wheel and column position sensor 24. After block 502, the first exemplary embodiment 500 of block 106 proceeds to block 506, as will be discussed in greater detail below. At block 504, the controller 14 determines the position of the instrument cluster display 18 using the instrument cluster display actuator 20. After block 504, the first exemplary embodiment 500 of block 106 proceeds to block 506.

Referring to FIG. 6, a first schematic diagram of the occupant 40 viewing the instrument cluster display 18 within the vehicle 12 is shown. With reference to FIG. 6 and continued reference to FIG. 5, at block 506, the controller 14 determines a plurality of eyeboxes 64. In the scope of the present disclosure, each of the plurality of eyeboxes 64 describes a volume in three-dimensional space within which the occupant 40 can see one of the plurality of regions 50. For example, a first eyebox 64a corresponds to the first region 50a. Therefore, if the occupant eye position is within the first eyebox 64a, the first region 50a is visible to the occupant 40. If the occupant eye position is not within the first eyebox 64a, the first region 50a is not visible to the occupant 40.

For example, a second eyebox 64b corresponds to the second region 50b. Therefore, if the occupant eye position is within the second eyebox 64b, the second region 50b is visible to the occupant 40. If the occupant eye position is not within the second eyebox 64b, the second region 50b is not visible to the occupant 40. For example, a third eyebox (not shown) corresponds to the third region 50c. Therefore, if the occupant eye position is within the third eyebox (not shown), the third region 50c is visible to the occupant 40. If the occupant eye position is not within the third eyebox (not shown), the third region 50c is not visible to the occupant 40.

In an exemplary embodiment, to determine a location, shape, and size of each of the plurality of eyeboxes 64, the controller 14 uses a geometrical model of a vehicle interior 66 of the vehicle 12. In the scope of the present disclosure, the geometrical model is a three-dimensional representation of the vehicle interior 66, including, for example, a virtual representation of the steering wheel 46, the instrument cluster display 18, and/or various additional elements of the vehicle.

The geometrical model is configured to receive the position of the steering wheel 46 determined at block 502 and the position of the instrument cluster display 18 determined at block 504 as inputs and provide the plurality of eyeboxes 64 as outputs. In a non-limiting example, the geometrical model works by analyzing the relative positions of the steering wheel 46, the instrument cluster display 18 within the three-dimensional space, accounting for obstacles or angles that obstruct visibility.

In another exemplary embodiment, to determine the location, shape, and size of each of the plurality of eyeboxes 64, the controller 14 uses a machine learning model trained (e.g., using supervised learning) to receive the position of the steering wheel 46 determined at block 502 and the position of the instrument cluster display 18 determined at block 504 as inputs and provide the plurality of eyeboxes 64 as outputs. Referring again to FIG. 5, after block 506, the first exemplary embodiment 500 of block 106 proceeds to block 508.

At block 508, the controller 14 determines a percentage of a predetermined time period for which the occupant eye position (determined at block 104) is within each of the plurality of eyeboxes 64. In an exemplary embodiment, the controller 14 retrieves one or more past occupant eye positions from the media 28 and compares the one or more past occupant eye positions to the position and bounds of each of the plurality of eyeboxes 64. In a non-limiting example, the predetermined time period is on the order of seconds (e.g., ten seconds). In another non-limiting example, the predetermined time period is on the order of minutes (e.g., two minutes). After block 508, the first exemplary embodiment 500 of block 106 proceeds to block 510.

At block 510, the controller 14 determines the region obstruction status of each of the plurality of regions 50. In an exemplary embodiment, the controller 14 compares the percentage of the predetermined time period for which the occupant eye position is within each of the plurality of eyeboxes 64 determined at block 508 to one or more predetermined thresholds. In a non-limiting example, if the percentage of the predetermined time period for which the occupant eye position is within an eyebox (e.g., the first eyebox 64a) is less than a first predetermined threshold (e.g., eighty percent), the region obstruction status of the corresponding region (e.g., the first region 50a) is determined to be the obstructed status.

Furthermore, if the percentage of the predetermined time period for which the occupant eye position is within an eyebox (e.g., the first eyebox 64a) is less than a second predetermined threshold, where the second threshold is less than the first predetermined threshold (e.g., ten percent), the corresponding region is determined to be statically obstructed. In the scope of the present disclosure, static obstruction means that the obstruction is caused by the geometry of the vehicle interior 66, and not by variation in occupant eye position (e.g., the position of the occupant seat 48, steering wheel 46, and/or instrument cluster display 18 are such that the occupant 40 is physically unable to see the region).

Furthermore, if the percentage of the predetermined time period for which the occupant eye position is within an eyebox (e.g., the first eyebox 64a) is less than the first predetermined threshold and greater than the second predetermined threshold (e.g., fifty percent), the corresponding region is determined to be dynamically obstructed. In the scope of the present disclosure, dynamic obstruction means that the obstruction is caused by variation in occupant eye position (e.g., the occupant 40 is moving their head 42 or looking around the vehicle interior 66). In an exemplary embodiment, the obstruction mitigation action discussed above in reference to block 108 of the method 100 is adjusted based at least in part on whether the obstruction is static or dynamic. After block 510, the first exemplary embodiment 500 of block 106 is concluded, and the method 100 proceeds as discussed above.

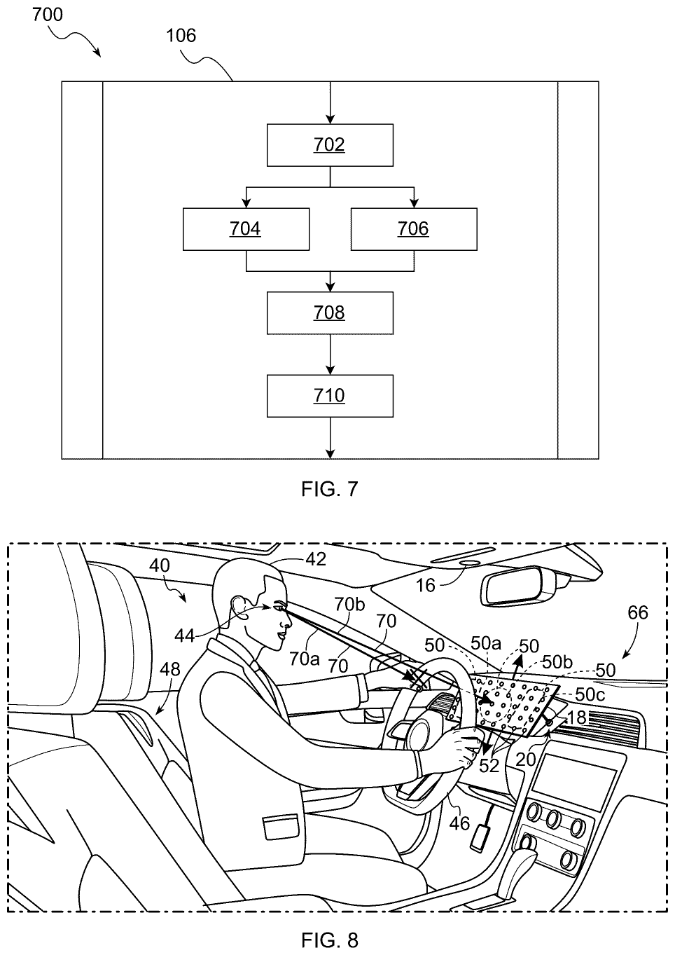

Referring to FIG. 7, a flowchart of a second exemplary embodiment 700 of block 106 (i.e., a second method for determination of the region obstruction status for each of the plurality of regions 50) is shown. Referring to FIG. 8, a second schematic diagram of the occupant 40 viewing the instrument cluster display 18 within the vehicle 12 is shown. With reference to FIGS. 7 and 8, the second exemplary embodiment 700 of block 106 begins at block 702. At block 702, the controller 14 determines a plurality of sightlines 70 between the occupant eye position determined at block 104 and each of plurality of regions 50. One or more of the plurality of sightlines corresponds to each of the plurality of regions 50. In a non-limiting example, a first sightline 70a is a sightline between the occupant eye position and one of the plurality of points 52 located within the first region 50a. As shown in FIG. 8, the first sightline 70a is obstructed by the steering wheel 46. A second sightline 70b is a sightline between the occupant eye position and one of the plurality of points 52 located within the second region 50b. As shown in FIG. 8, the second sightline 70b is not obstructed by the steering wheel 46.

In an exemplary embodiment, to determine the plurality of sightlines 70, the controller 14 uses the geometrical model of the vehicle interior 66 of the vehicle 12. The geometrical model is a three-dimensional representation of the vehicle interior 66, including, for example, a virtual representation of a location of the instrument cluster display 18 relative to the occupant eye position. Referring again to FIG. 7, after block 702, the second exemplary embodiment 700 of block 106 proceeds to blocks 704 and 706.

At block 704, the controller 14 determines the position of the steering wheel 46 using the steering wheel and column position sensor 24. After block 704, the second exemplary embodiment 700 of block 106 proceeds to block 708, as will be discussed in greater detail below. At block 706, the controller 14 determines the position of the instrument cluster display 18 using the instrument cluster display actuator 20. After block 706, the second exemplary embodiment 700 of block 106 proceeds to block 708.

With continued reference to FIGS. 7 and 8, at block 708, the controller 14 determines a sightline obstruction status of each of the plurality of sightlines 70. The sightline obstruction status includes one of: an obstructed status or an unobstructed status. The obstructed status indicates that a given sightline is not an uninterrupted path from the occupant eye position to one of the plurality of points 52 on the instrument cluster display 18. In a non-limiting example, the first sightline 70a has the obstructed status because the first sightline 70a is interrupted by the steering wheel 46. The unobstructed status indicates that a given sightline is an uninterrupted path from the occupant eye position to one of the plurality of points 52 on the instrument cluster display 18. In a non-limiting example, the second sightline 70b has the unobstructed status because the second sightline 70b is not obstructed (i.e., interrupted or blocked by) the steering wheel 46.

In an exemplary embodiment, the sightline obstruction status of each of the plurality of sightlines 70 is determined based at least in part on the position of the steering wheel 46 determined at block 704 and the position of the instrument cluster display 18 determined at block 706. In a non-limiting example, the controller 14 uses the geometrical model to determine the sightline obstruction status of each of the plurality of sightlines 70. In a non-limiting example, the geometrical model is configured to receive the plurality of sightlines 70 determined at block 702, the position of the steering wheel 46 determined at block 704, and the position of the instrument cluster display 18 determined at block 706 as inputs and provide the sightline obstruction status of each of the plurality of sightlines 70 as outputs. In a non-limiting example, the geometrical model works by analyzing the positions of the steering wheel 46 and the instrument cluster display 18 relative to the path of each of the plurality of sightlines 70 within the three-dimensional space, accounting for obstacles or angles that obstruct visibility. Referring again to FIG. 7, after block 708, the second exemplary embodiment 700 of block 106 proceeds to block 710.

With continued reference to FIGS. 7 and 8, at block 710, the controller 14 determines the region obstruction status of each of the plurality of regions 50 based at least in part on the sightline obstruction status of each of the plurality of sightlines 70 determined at block 708. In an exemplary embodiment, if any of the plurality of sightlines 70 corresponding to any of the plurality of points 52 within a given one of the plurality of regions 50 has the obstructed status, the region obstruction status of the given region is determined to be the obstructed status (e.g., the first region 50a as shown in FIG. 8). If none of the plurality of sightlines 70 corresponding to any of the plurality of points 52 within a given one of the plurality of regions 50 has the obstructed status, the region obstruction status of the given region is determined to be the unobstructed status (e.g., the second region 50b as shown in FIG. 8). In other words, the region obstruction status of each of the plurality of regions 50 of the instrument cluster display 18 is determined to be equal to the sightline obstruction status of a corresponding one or more of the plurality of sightlines 70.

In another exemplary embodiment, if a first sightline corresponding to a first point of the plurality of points 52 has the obstructed status and a second sightline corresponding to a second point of the plurality of points 52 also has the obstructed status, where the first point and the second point are proximal to one another but not necessarily adjacent, than any regions located between the first point and the second point are determined to have the obstructed region obstruction status.

In another exemplary embodiment, if greater than a threshold percentage (e.g., fifty percent) of the plurality of sightlines 70 corresponding to any of the plurality of points 52 within a given one of the plurality of regions 50 has the obstructed status, the region obstruction status of the given region is determined to be the obstructed status. Otherwise, the region obstruction status is determined to be the unobstructed status. It should be understood that various additional techniques for determining the region obstruction status of each of the plurality of regions 50 based at least in part on the sightline obstruction status of each of the plurality of sightlines 70 are within the present disclosure. Referring again to FIG. 7, after block 710, the second exemplary embodiment 700 of block 106 is concluded, and the method 100 proceeds as discussed above.

The system 10 and method 100 of the present disclosure offer several advantages. By dynamically updating the obstruction mitigation actions based on the occupant eye position, the system 10 and method 100 are adaptive to changes in occupant position and position of vehicle components (e.g., steering wheel position, seat position, etc.). Using the system 10 and method 100, the operation of the instrument cluster display 18 is adjusted to ensure that the occupant 40 can always view critical information (e.g., vehicle speed). Furthermore, using the system 10 and method 100, the operation of the instrument cluster display 18 is adjusted to enable the occupant 40 to see and interact with all information and vehicle features presented on the instrument cluster display 18, increasing occupant comfort and convenience.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for increasing display visibility in a vehicle, the method comprising:
determining an occupant eye position of an occupant of the vehicle using an occupant position tracking device;
determining a region obstruction status of each of a plurality of regions of an instrument cluster display of the vehicle based at least in part on the occupant eye position, wherein the region obstruction status includes one of: an obstructed status and an unobstructed status; and
performing an obstruction mitigating action in response to determining that the region obstruction status of one or more of the plurality of regions of the instrument cluster display is the obstructed status.

2. The method of claim 1, wherein determining the region obstruction status of each of the plurality of regions of the instrument cluster display further comprises:
determining a plurality of eyeboxes, wherein each of the plurality of eyeboxes describes a volume in three-dimensional space within which the occupant can see one of the plurality of regions, and wherein each of the plurality of eyeboxes corresponds to a corresponding one of the plurality of regions; and
determining the region obstruction status of each of the plurality of regions based at least in part on the plurality of eyeboxes and the occupant eye position.

3. The method of claim 2, wherein determining the plurality of eyeboxes further comprises:
determining a position of the instrument cluster display;
determining a position of a steering wheel of the vehicle; and
determining the plurality of eyeboxes based at least in part on the position of the instrument cluster display and the position of the steering wheel of the vehicle.

4. The method of claim 3, wherein determining the plurality of eyeboxes further comprises:
determining the plurality of eyeboxes using a geometrical model of a vehicle interior of the vehicle based at least in part on: the position of the instrument cluster display and the position of the steering wheel of the vehicle.

5. The method of claim 2, wherein determining the region obstruction status further comprises:
determining a percentage of a predetermined time period for which the occupant eye position is within each of the plurality of eyeboxes; and
determining the region obstruction status of each of the plurality of regions based at least in part on the percentage of the predetermined time period for which the occupant eye position is within each of the plurality of eyeboxes.

6. The method of claim 5, wherein determining the region obstruction status further comprises:
determining the region obstruction status of each of the plurality of regions by comparing the percentage of the predetermined time period for which the occupant eye position is within each of the plurality of eyeboxes to a predetermined threshold.

7. The method of claim 1, wherein determining the region obstruction status of each of the plurality of regions of the instrument cluster display further comprises:
determining a plurality of sightlines between the occupant eye position and each of the plurality of regions, wherein each of the plurality of sightlines corresponds to a corresponding one of the plurality of regions; and
determining a sightline obstruction status of each of the plurality of sightlines using a geometrical model of a vehicle interior of the vehicle based at least in part on: a position of the instrument cluster display and a position of a steering wheel of the vehicle, wherein the sightline obstruction status includes one of: the obstructed status and the unobstructed status; and
determining the region obstruction status of each of the plurality of regions of the instrument cluster display to be equal to the sightline obstruction status of a corresponding one of the plurality of sightlines.

8. The method of claim 1, wherein performing the obstruction mitigating action further comprises:
prompting the occupant to reposition at least one of: an occupant seat, a steering wheel of the vehicle, and the instrument cluster display.

9. The method of claim 1, wherein performing the obstruction mitigating action further comprises:
repositioning the instrument cluster display using an instrument cluster display actuator.

10. The method of claim 1, wherein performing the obstruction mitigating action further comprises:
repositioning one or more user interface elements displayed in a first region of the one or more of the plurality of regions having the obstructed status to a second region of the one or more of the plurality of regions having the unobstructed status.

11. A system for increasing display visibility in a vehicle, the system comprising:
an instrument cluster display;
an occupant position tracking device;
a seat position sensor;
a controller in electrical communication with the instrument cluster display, the occupant position tracking device, and the seat position sensor, wherein the controller is programmed to:
determine an occupant eye position of an occupant of the vehicle using the occupant position tracking device and the seat position sensor;
determine a region obstruction status of each of a plurality of regions of the instrument cluster display of the vehicle based at least in part on the occupant eye position, wherein the region obstruction status includes one of: an obstructed status and an unobstructed status; and
reposition one or more user interface elements displayed in a first region of the one or more of the plurality of regions of the instrument cluster display having the obstructed status to a second region of the one or more of the plurality of regions of the instrument cluster display having the unobstructed status.

12. The system of claim 11, wherein to determine the region obstruction status of each of the plurality of regions of the instrument cluster display, the controller is further programmed to:
determine a plurality of eyeboxes, wherein each of the plurality of eyeboxes describes a volume in three-dimensional space within which the occupant can see one of the plurality of regions, and wherein each of the plurality of eyeboxes corresponds to a corresponding one of the plurality of regions; and
determine the region obstruction status of each of the plurality of regions based at least in part on the plurality of eyeboxes and the occupant eye position.

13. The system of claim 12, wherein to determine the plurality of eyeboxes, the controller is further programmed to:
determine a position of the instrument cluster display;
determine a position of a steering wheel of the vehicle; and
determine the plurality of eyeboxes using a geometrical model of a vehicle interior of the vehicle based at least in part on: the position of the instrument cluster display and the position of the steering wheel of the vehicle.

14. The system of claim 13, wherein to determine the region obstruction status, the controller is further programmed to:
determine a percentage of a predetermined time period for which the occupant eye position is within each of the plurality of eyeboxes; and
determine the region obstruction status of each of the plurality of regions by comparing the percentage of the predetermined time period for which the occupant eye position is within each of the plurality of eyeboxes to a predetermined threshold.

15. The system of claim 11, wherein to determine the region obstruction status of each of the plurality of regions of the instrument cluster display, the controller is further programmed to:
determine a plurality of sightlines between the occupant eye position and each of the plurality of regions, wherein each of the plurality of sightlines corresponds to a corresponding one of the plurality of regions; and
determine a sightline obstruction status of each of the plurality of sightlines, wherein the sightline obstruction status includes one of: the obstructed status and the unobstructed status; and
determine the region obstruction status of each of the plurality of regions of the instrument cluster display based at least in part on the region obstruction status of each of the plurality of sightlines.

16. The system of claim 15, wherein to determine the sightline obstruction status of each of the plurality of sightlines, the controller is further programmed to:
determine the sightline obstruction status of each of the plurality of sightlines using a geometrical model of a vehicle interior of the vehicle based at least in part on: a position of the instrument cluster display and a position of a steering wheel of the vehicle.

17. The system of claim 16, wherein to determine the region obstruction status of each of the plurality of regions of the instrument cluster display, the controller is further programmed to:
determine the region obstruction status of each of the plurality of regions of the instrument cluster display to be equal to the sightline obstruction status of a corresponding one of the plurality of sightlines.

18. A method for increasing display visibility in a vehicle, the method comprising:
determining an occupant eye position of an occupant of the vehicle using an occupant position tracking device;
determining a region obstruction status of each of a plurality of regions of an instrument cluster display of the vehicle based at least in part on the occupant eye position, wherein the region obstruction status includes one of: an obstructed status and an unobstructed status; and
performing an obstruction mitigating action in response to determining that the region obstruction status of one or more of the plurality of regions of the instrument cluster display is the obstructed status, wherein the obstruction mitigating action includes repositioning the instrument cluster display using an instrument cluster display actuator.

19. The method of claim 18, wherein determining the region obstruction status of each of the plurality of regions of the instrument cluster display further comprises:
determining a position of the instrument cluster display;
determining a position of a steering wheel of the vehicle;
determining a plurality of eyeboxes based at least in part on the position of the instrument cluster display and the position of the steering wheel of the vehicle, wherein each of the plurality of eyeboxes describes a volume in three-dimensional space within which the occupant can see one of the plurality of regions, and wherein each of the plurality of eyeboxes corresponds to a corresponding one of the plurality of regions;
determining a percentage of a predetermined time period for which the occupant eye position is within each of the plurality of eyeboxes; and
determining the region obstruction status of each of the plurality of regions by comparing the percentage of the predetermined time period for which the occupant eye position is within each of the plurality of eyeboxes to a predetermined threshold.

20. The method of claim 19, wherein performing the obstruction mitigating action further comprises:
repositioning one or more user interface elements displayed in a first region of the one or more of the plurality of regions having the obstructed status to a second region of the one or more of the plurality of regions having the unobstructed status.
